(19) United States
(12) Patent Application Publication
(10) Pub. No.: US 2003/0221908 A1
(43) Pub. Date: Dec. 4, 2003

(54) Foldable safety apparatus for an upper region of a ready-mix concrete truck

(76) Inventor: Donald Fix, St. Charles, MO (US)

Correspondence Address: HAVERSTOCK, GARRETT & ROBERTS, 611 OLIVE STREET, SUITE 1610, ST. LOUIS, MO, 63101, US

(21) Appl. No.: 10/158,423

(22) Filed: May 29, 2002

(51) Int. Cl. E06C 5/00

(52) U.S. Cl. 182/127; 182/86

(57) ABSTRACT

A safety apparatus for an elevated region of a ready-mix concrete truck. The safety apparatus includes at least one elongate, rigid railing element having opposite end portions and a concave portion disposed therebetween, the end portions being supported by structure on the truck for pivotal movement of the railing element between a deployed position located generally above and extending around the peripheral portion or region of the elevated region, and a stored position angularly related to the deployed position above or below the deployed position, and an element positionable in a predetermined position for holding the railing element in the deployed position. In the deployed position, the railing element allows a person to move between a ladder or other climbable element and the elevated region while providing protection against the person falling outwardly away therefrom. The apparatus can optionally include a second elongate, rigid railing element movable and positionable as above. When in the stored position, the railing element or elements are optionally located so as to impede movement of a person between the ladder or other climbable element and the elevated region.

### TECHNICAL FIELD

The present invention related generally to ready-mix concrete trucks, and more particularly, to safety apparatus including a safety railing or guard for an elevated element or platform on a ready-mix truck which railing is deployable above and in outwardly extending relation to the elevated element or platform for providing a passage for movement onto and off of the element or platform and also protection against falling for a person or operator when on the elevated element or platform and when moving onto or off of the element or platform, the railing or guard being storable when the element or platform is not in use so as to be less likely to come into contact with elevated structures, apparatus, equipment, and/or objects typically located in the loading area of a concrete plant where ready-mix trucks are loaded with material, and at job sites and other locations.

### BACKGROUND ART

Commonly, persons such as concrete plant operators, drivers, laborers and the like, are required to occasionally climb to elevated regions on a ready-mix concrete truck, particularly, elevated regions in the vicinity of the elevated open end of the rotatable concrete mixing drum thereof, for inspecting the contents thereof, and/or for servicing, maintaining, or cleaning aspects of the truck located in this region, such as the fill chute, and the like, and for placing admixes and other agents in concrete present in the drum. Typically, the truck includes a ladder or other apparatus which can be climbed for accessing the elevated region of the truck, and, in many instances, a platform is provided adjacent the upper end of the ladder, on which a person can stand for inspecting or performing work required at the elevated location. To allow proper access to the equipment at the elevated location, the upper regions of the ladder and the platform, if provided, will typically be 7 to 10 feet above the ground or other surface on which the truck is located, making it desirable to provide safety apparatus for persons thereon.

One known safety apparatus usable is a harness or sling to be worn by the person and attachable to an upper region of the truck. However, it is anticipated that sometimes the person will forget to wear the apparatus, or intentionally will not wear it due to discomfort, heat, or for other reasons. Also known is to use a chain or movable guard railing section or gate securable between supports on opposite sides of an access region of an elevated region or platform. However, such known chains and gates provide no fall protection for a person when moving onto or off of an elevated platform and at other times when the chain or gate is not in place. Securing a chain or gate once a person is on the platform, and unsecuring it to leave, can also require a person to make difficult moves, such as turning around on the platform, which can increase potential for falling and injury. Additionally, and importantly, ready-mix trucks often must be maneuvered into position beneath a fill chute of a concrete plant for receiving a load of concrete therefrom, and often will have to be maneuvered at job sites where the concrete is to be placed, at which locations various structures, apparatus, equipment and other obstacles at about the same height as the upper areas of the ready-mix truck may be present, thereby providing a danger of damage to the structure and/or equipment and/or any elements on or protruding from upper regions of the truck which come into contact with the equipment or other obstacles. In this regard, to minimize the occurrence of accidental contact between the elements on the upper regions of a ready-mix truck and equipment and other obstacles present at cement plants, job sites, and the like, is desirable to minimize the profile of the upper regions of the truck and the number of items extending outwardly therefrom.

Thus, what is sought is safety apparatus for an elevated region of a ready-mix concrete truck which provides desired fall protection for a person working in the elevated region, and/or when entering or leaving the region using a ladder or other climbable element, which safety railing or guard provides easy access to and from the elevated region, can be stored when not in use in a non-obtrusive manner or location with respect to the front and rear profile of the truck, and which safety railing or guard can be easily, safely, and conveniently moved between its deployed and stored positions.

### DISCLOSURE OF THE INVENTION

According to the present invention, safety apparatus for an elevated region of a ready-mix concrete truck which provides many of the sought after properties discussed above, is disclosed. According to a preferred aspect of the invention, the safety apparatus includes at least one elongate, rigid railing element having opposite end portions and a concave portion disposed therebetween, the end portions being supported by structure on the truck for pivotal movement of the railing element between a deployed position located generally above and extending around a peripheral portion or region of the elevated region, and a stored position angularly related to the deployed position above or below the deployed position, and an element positionable in a predetermined position for holding the railing element in the deployed position. In the deployed position, the railing element provides a passage through which a person can move between a ladder or other climbable element and the elevated region while providing protection against the person falling outwardly away therefrom.

Preferably, the element positionable in the predetermined position for holding the railing element in the deployed position includes an elongate arm connected to and extending downwardly from the railing element and connected to a pivotally mounted ladder portion, such that when the ladder portion is pivotally moved to a position for climbing thereon to the elevated region, the railing element is held by the ladder in the deployed position. More particularly, the preferred construction includes a conventional ladder including an upper ladder portion fixedly mounted to the truck, the above-discussed pivotal ladder portion being mounted for pivotal movement relative to the upper ladder portion between a folded position oriented generally parallel to or at a small acute angle to the upper ladder portion and an unfolded position generally parallel to and extending downwardly from the upper ladder portion, and the element positionable for holding the railing element in the deployed position includes an arm connected between the railing element and the lower ladder portion and including a linkage arrangement operable for positioning the railing element in the deployed position when the lower ladder portion is moved to the unfolded position, and positioning the railing element in the stored position when the lower ladder portion is moved to the folded position.

### BRIEF DESCRIPTION OF THE DRAWINGS

FIG. 1 is a fragmentary simplified schematic representation of one side of a rear end of a representative conventional ready-mix concrete truck including foldable safety apparatus for an elevated region of the truck according to the present invention;

FIG. 2 is a fragmentary simplified schematic perspective representation of the truck and safety apparatus of FIG. 1, illustrating a person in the elevated region;

FIG. 3 is another fragmentary simplified perspective schematic representation of the truck and safety apparatus of FIG. 1;

FIG. 4 is an enlarged fragmentary perspective view of an arm and linkage arrangement of the safety apparatus of FIG. 1, showing connection thereof to a lower ladder portion of a foldable ladder of the truck of FIG. 1;

FIG. 5 is a front view of an elevated platform and the foldable ladder of the truck of FIG. 1 in an unfolded position, for positioning the safety apparatus in a deployed position as shown;

FIG. 6 is another front view of the elevated platform and ladder of the truck of FIG. 1, showing the ladder being moved from the unfolded position (in phantom) to a folded position for moving the safety apparatus from the deployed position (in phantom) to a stored position;

FIG. 7 is another fragmentary perspective view of the truck and safety apparatus of FIG. 1, showing the safety apparatus in the stored position;

FIG. 8 is an enlarged fragmentary perspective view of the foldable ladder and aspects of the safety apparatus, illustrating one embodiment of apparatus for holding the foldable ladder in the folded position for holding the safety apparatus in the stored position;

FIG. 9 is a fragmentary side view of the elevated platform of the truck of FIG. 1, including an alternative railing construction and the foldable safety apparatus of the invention thereon;

FIG. 10 is a fragmentary front view of the elevated platform, railing, and safety apparatus of FIG. 9; and

FIG. 11 is a fragmentary rear view of the elevated platform, railing, and safety apparatus of FIG. 9.

### DETAILED DESCRIPTION OF THE PREFERRED EMBODIMENTS

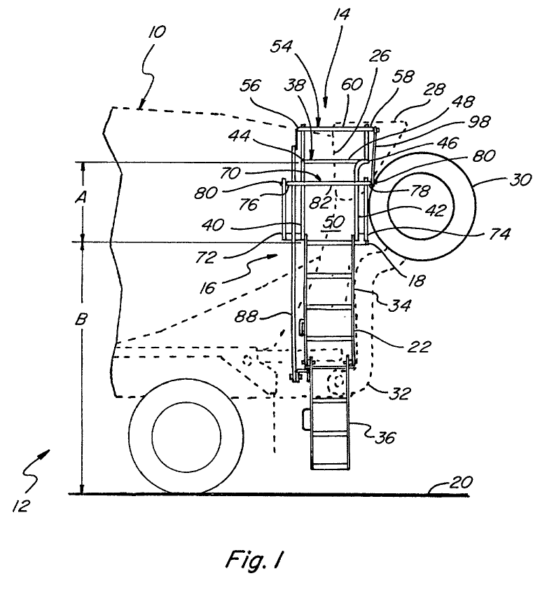

Referring now to the drawings wherein preferred embodiments of the present invention are shown, in FIG. 1, a rear end 10 of a typical ready-mix concrete truck 12 is shown, including foldable safety apparatus 14 constructed and operable according to the teachings of the present invention, for providing fall protection for a person located on an elevated region of truck 12, as generally denoted by region 16. Here, elevated region 16 generally includes an elevated platform 18 conventionally mounted to structure on the upper regions of rear end 10 at an elevation of about 7 to 10 feet above a surface 20 on which truck 12 is located, such as the ground or pavement, and also upper regions of a foldable ladder 22 disposed between surface 20 and platform 18. Truck 10 includes a rotatable hollow drum 24 having an open end 26 which is elevated relative to an opposite end thereof, for receiving ready-mix concrete from a concrete plant (not shown) through a chute 28 mounted on truck 12 in alignment with open end 26. Drum 24 includes at least one internal helical flight or rib extending therearound (not shown) which mixes the ready-mix concrete in the drum when rotated in a first direction, and dispenses the concrete through open end 26 when rotated in the opposite direction. Truck 12 additionally includes a pair of wheels 30 mounted on a pivotal armature 32 for movement between a position generally in or adjacent to elevated region 16 when not in use, and a lowered position in contact with surface 20 for better distributing heavy loads, as required.

A person such as an operator, driver, or laborer will typically climb ladder 22 to reach platform 18 and stand thereon for performing any of a variety of functions, including, but not limited to, inspecting concrete in or flowing into drum 24; placing an admixture, such as a colorant, cure retarder, or other chemical therein; cleaning; maintaining; and/or repairing apparatus in or near elevated region 16. Platform 18 and ladder 22 can be rendered slippery by the presence of water and/or mud or other slippery agents on the person's shoes or boots and/or on the surfaces of platform 18 and/or ladder 22, such that it is possible that the person could fall from platform 18 or ladder 22 when standing thereon or climbing therebetween. Persons have also been known to fall from platforms such as platform 18 and ladders such as ladder 22 due to inattention, and/or loss of grip, and/or improper climbing technique. Due to the height of platform 18 and upper regions of ladder 22, which as noted above can be about 7 to 10 feet above surface 20, the possibility of injury from a fall is significant.

Ladder 22 includes an upper ladder portion 34 fixedly mounted to appropriate structural elements of truck 12, such as straps, braces and the like. Ladder 22 includes a lower ladder portion 36 mounted to upper ladder portion 34 for pivotal movement between an unfolded position extending downwardly toward surface 20 as shown in FIGS. 1, 4 and 5, and a folded position generally beside and parallel or near parallel to upper ladder portion 34, as illustrated in FIGS. 6, 7 and 8.

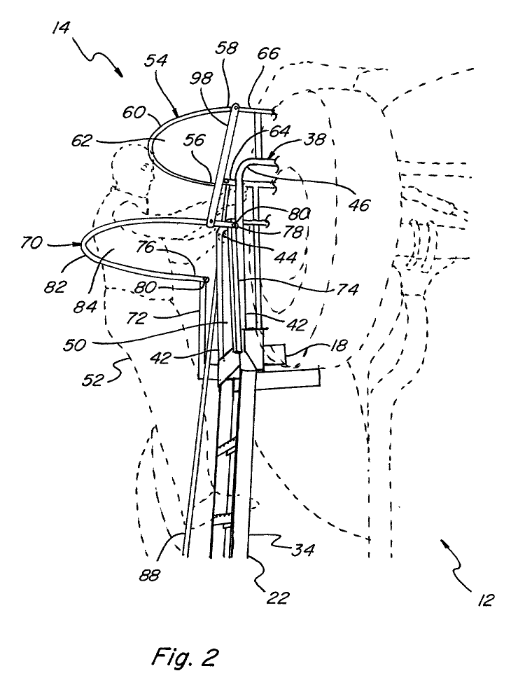

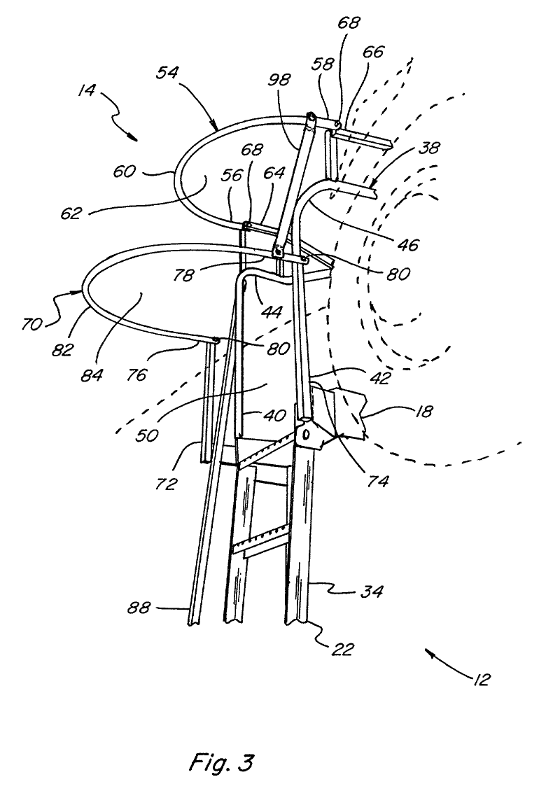

Referring also to FIGS. 2 and 3, truck 12 includes a fixed safety railing 38 of bent or welded together tubular members, including end portions 40 and 42 fixedly connected to elevated platform 18 adjacent to opposite forward and rear outer corners thereof by welding or other suitable attachment, railing 38 extending upwardly from end portions 40, 42 to a pair of bends 44, 46, respectively, located a predetermined distance above platform 18. Railing 38 extends generally horizontally from bends 44, 46 sidewardly generally toward drum 24 and chute 28, to an inward railing portion 48 which spans a forward to rearward extent of platform 18 along a peripheral edge thereof closest to drum 24. Fixed safety railing 38 essentially has a U-shape profile when viewed from above or below, extending around the forward and rearward peripheral edges of platform 18 and the sideward peripheral edge thereof closest to drum 24, such that a sidewardly open access region 50 is defined between upstanding portions of railing 38 between end portions 40, 42 and bends 44, 46 above a corresponding peripheral edge or region of platform 18. As shown in FIG. 1, railing 38 is at a representative height, denoted by distance A, above platform 18 of about 36 inches, which provides adequate safety for a person standing on platform 18, while still allowing the person to reach beyond inward railing portion 48 to chute 28 and other regions of truck 12. Platform 18 is shown located a representative distance, denoted by distance B, above surface 20, of about 7 to about 10 feet. Upper ladder portion 34 of foldable ladder 22 extends upwardly to and preferably connects to platform 18 adjacent the connection of end portion 40, 42 thereto, such that a person can climb between ladder 22 and platform 18 through access region 50. When a person is at this height on platform 18, or is climbing onto or off of platform 18 in or in the vicinity of access region 50, as illustrated by person 52 in FIG. 2, there is the possibility of being injured by a fall, particularly by falling outwardly away from platform 18 and ladder 22.

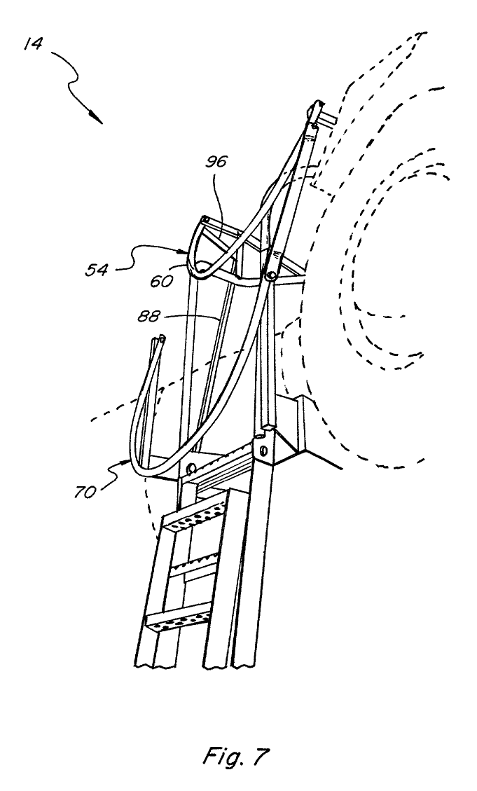

To reduce the possibility of such an injury, foldable safety apparatus 14 is configured and intended for providing fall protection for a person while on platform 18 and climbing or moving between platform 18 and ladder 22. Apparatus 14 includes a rigid elongate first railing element 54 preferably of tubular metal or other suitable material including a first end portion 56 and a second end portion 58 opposite end portion 56, and an intermediate portion 60 extending between end portions 56, 58. Intermediate portion 60 shown has an arcuate or curved concave shape defining and extending partially around a passage or area 62, as shown in FIGS. 2 and 3, above and in alignment with access region 50, through which the upper body portion of a person, such as person 52, can pass when climbing onto or off of platform 18. End portions 56 and 58 are mounted on and supported for pivotal movement relative to, upstanding support members 64, 66 mounted to railing 38 adjacent bends 44, 46, respectively. End portions 56, 58 are pivotally connected to support members 64, 66, respectively, by suitable pivotal elements, such as pins 68 shown, such that railing element 54 is pivotally movable about a generally horizontal axis between a generally horizontally extending deployed position (FIGS. 1, 2, 3, and 5) and a folded or stored position oriented at a large acute angle to the deployed position, preferably extending downwardly (FIGS. 6 and 7). Here, it should be noted that intermediate portion 60 of railing element 54 has a sideward extent, generally perpendicular to an imaginary horizontal axis through pins 68, which makes area 62 sufficiently large to allow passage of the upper body of a person therethrough when climbing onto or off of platform 18, but which still positions railing element 54 for providing fall protection for the person, both when climbing to or from and also when standing on platform 18. This combination of accessibility and fall protection is a function of the elevation of railing element 54 a suitable distance above distance A, which is preferably about 6 inches or so, which locates railing element 54 about 42 inches above platform 18, and the outward extent of the concave intermediate portion thereof, as will be discussed.

To optionally and preferably provide additional fall protection for a person climbing between platform 18 and ladder 22, safety apparatus 14 includes a second railing element 70 also preferably of rigid tubular metal or other suitable construction pivotally supported on and movable relative to a pair of upstanding support members 72 and 74 adjacent opposite sides of the upper end of upper ladder portion 34, for pivotal movement between a generally horizontal deployed position (FIGS. 1, 2, 3, and 5) and a folded or stored position (FIGS. 6 and 7). Second railing element 70 includes opposite first and second end portions 76 and 78 which are pivotally connected using suitable members, such as pins 80, to support members 72 and 74, respectively, and an intermediate portion 82 extending between end portions 76, 78. Intermediate end portion 82 has an arcuate or curved concave shape defining and partially surrounding a second area 84 which, when railing element 70 is in its generally horizontal deployed position, is slightly larger than and located spaced below area 62 defined by railing element 54 essentially forming a passage in combination therewith. Referring more particularly to FIG. 2, such passage is desirably sufficient for a person to pass through when making the transition between platform 18 and ladder 22 while railing elements 54 and 70 provide fall protection for the person, as illustrated by representative person 52.

Here, it should be noted that although intermediate portions 60 and 82 of railing elements 54 and 70 are shown as having curved or arcuate shapes, other concave shapes, such as rectangular, hexagonal, oval, or the like, and other shapes which provide desired degrees of accessibility and fall protection, can be used, as desired. It should also be noted that although apparatus 14 is shown connected to platform 18 and railing 38 by upstanding support members 64, 66 and 72 and 74, other apparatus or members could be used for positioning and supporting apparatus 14 as desired and required for a particular ready-mix concrete truck application or configuration.

Due to the possibility of space constraints in the loading areas of concrete plants, job sites and other locations, it is preferred that railing elements 54 and 70 be pivotable to stored locations which reduce the overall sideward profile of truck 12, to lessen the potential for damaging contact with apparatus, equipment and structures located at about the same elevation as the railing elements. It is also desirable for the railing elements, or at least one of them, to serve as a barrier to entry onto platform 18 when the railing elements are in the stored position, such that a person will not be easily able to inadvertently or intentionally climb onto platform 18 without the railing elements being deployed.

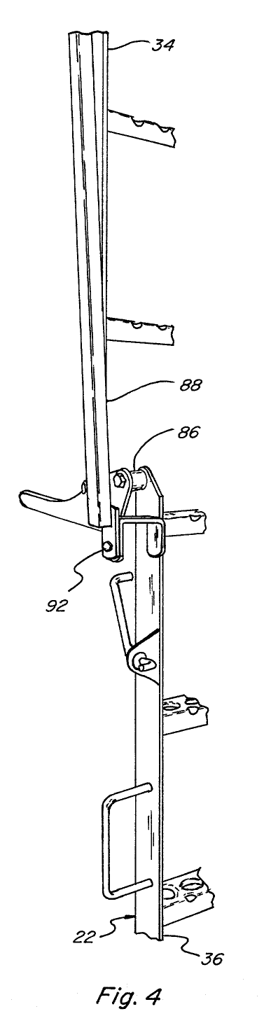

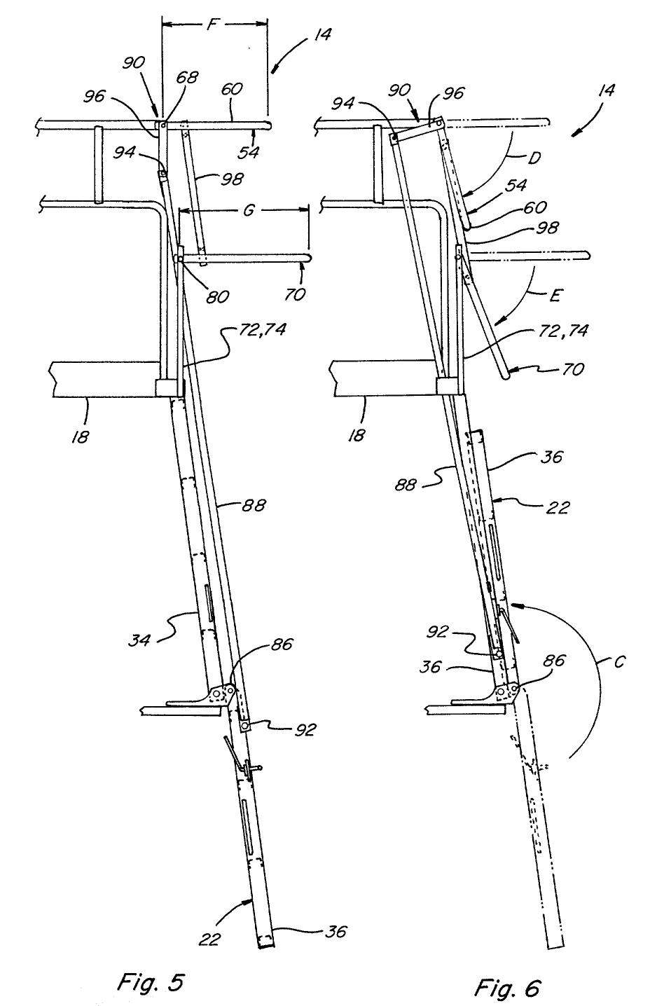

Referring more particularly to FIGS. 4, 5 and 6, lower ladder portion 36 and ladder 22 is mounted for pivotal movement relative to upper ladder portion 34 by a pair of pivots 86, to allow manually moving lower ladder portion 36 between the unfolded positions (FIGS. 4 and 5) and the folded position (FIG. 6). It is desirable for lower ladder portion 36 to be in its folded position when truck 12 is moving, and when there is otherwise no reason for a driver, operator or other person to be on platform 18. This coincides with the times when railing elements 54 and 70 are to be in their stored positions, for decreasing the profile of the upper portions of truck 12 when viewed from the front and rear, for reducing the possible occurrence of contact with elevated structures, apparatus, and equipment, and also for providing an impediment or barrier for a person attempting to climb onto platform 18, or the upper rungs of ladder 22, for safety purposes.

Generally, at any time that lower ladder portion 36 is unfolded, first and second railing elements 54 and 70 are preferably deployed. To accomplish this, it is desirable that railing elements 54 and 70 be deployable from a location beneath platform 18, and most preferably by the movement of lower ladder portion 36 from the folded position to the unfolded position, such that the person is less likely to fail to deploy the present safety apparatus. This is preferably accomplished utilizing a combination of an elongate arm 88 and a linkage arrangement 90 connected between lower ladder portion 36 and railing elements 54 and/or 70. In the preferred embodiment, arm 88 has a lower end connected by a pivot 92 to lower ladder portion 36 adjacent the upper end thereof. Arm 88 includes an upper end pivotally connected by a pivot 94 to a first link 96 of linkage arrangement 90 fixedly connected to railing element 54 at about a perpendicular angle to intermediate portion 60 thereof, as best shown in FIGS. 5 and 6. Linkage arrangement 90 additionally includes a connecting link 98 pivotally connected to both railing element 54 and railing element 70.

Referring in particular to FIG. 5, when lower ladder portion 36 is unfolded and extending downwardly from and generally parallel to upper ladder portion 34, arm 88 will hold first link 96 in a downward position, such that railing element 54 fixedly connected to link 96 will be maintained and held in the deployed position, extending generally outwardly as shown. Connecting link 98 is connected between railing elements 54 and 70 so as to position railing element 70 in its deployed position as also shown. Then, referring more particularly to FIGS. 6 and 7, when lower ladder portion 36 is pivotally moved to its folded position, denoted by arrow C, arm 88 is driven or displaced upwardly thereby so as to pivot railing element 54 downwardly, as denoted by arrow D, to its stored position as shown. At the same time, due to the pivotal connection of connecting link 98 between railing elements 54 and 70, railing element 70 is pivoted downwardly, as denoted by arrow E, to its stored position, as also shown. Deployment of railing elements 54 and 70 is accomplished by pivotally moving lower ladder portion 36 in the direction opposite direction C, which serves to pull or allow arm 88 to move downwardly to pivot railing elements 54 and 70 upwardly to the deployed positions thereof, in the direction opposite arrows D and E, respectively. Here, it should be observed that railing elements 54 and 70 when in their stored positions, are preferably intentionally located so as to effectively serve as barriers to movement of a person onto platform 18 from ladder 22. It should also be noted that the pivotal movement of lower ladder portion 36 to the position of FIG. 5 is sufficient to hold railing elements 54 and 70 in the deployed position, even when a weight or load is exerted thereagainst, such as in the event an adult person falls or leans against either or both of railing elements 54 and 70, thus providing the desired safety and fall protection. Contributing reasons for this effect include the weight of lower ladder portion 36 and the mechanical advantage exerted thereby over arm 88 by virtue of the greater distance between the center of gravity of ladder portion 36 and pivot 86 compared to the distance of pivot 92 to pivot 86, providing an over center clamping or holding effect.

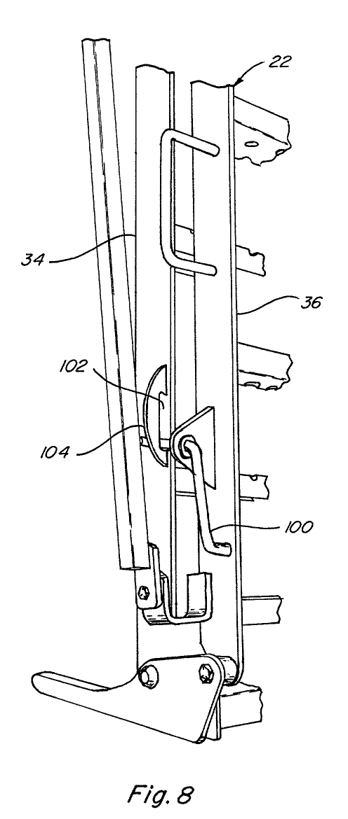

Referring to FIG. 8, it is desirable to provide elements for holding lower ladder portion 36 of ladder 22 in its folded position beside upper ladder portion 34, both to prevent damage to ladder 22 when truck 12 is moving, and to prevent inadvertent or accidental deployment of railing elements 54 and 70. This can be accomplished utilizing any suitable structure, including, for instance, a pawl 100 pivotally mounted on lower ladder portion 36 and receivable in a slot 102 between a bracket 104 and a rail of lower ladder portion 34, pawl 100 being rotatable when in slot 102 to a position for engaging bracket 104 for holding ladder portions 34 and 36 together.

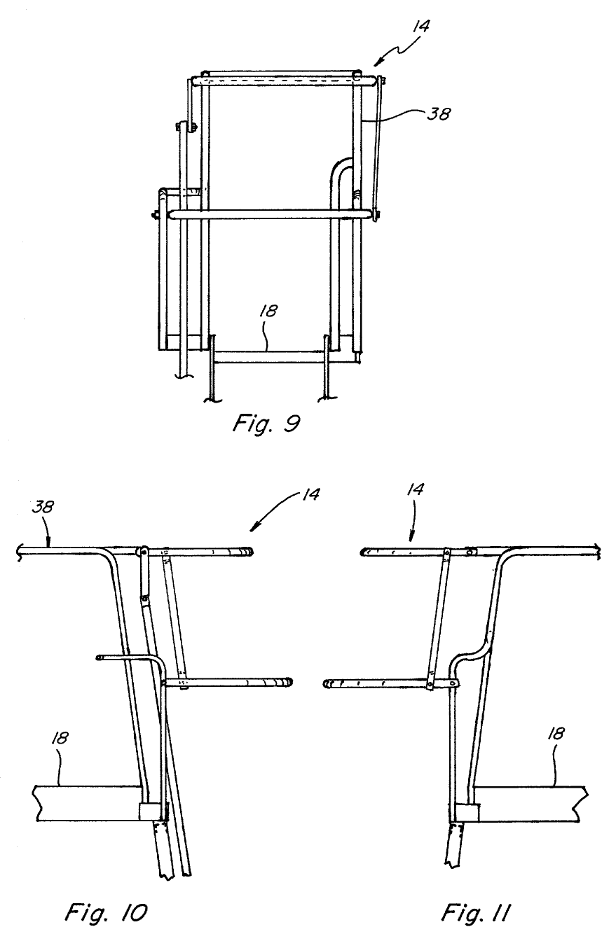

Referring to FIGS. 9, 10 and 11, foldable safety apparatus 14 is shown directly mounted to a fixed safety railing 38 located a desired distance above platform 18 and operable in the above-described manner, the advantage achieved being the elimination of any necessity for additional support members 64, 66. For instance, the upper portion of fixed safety railing 38 could be located at a distance of about 42 inches above platform 88, as desired. It should also be remembered that it is contemplated according to the present invention that the present foldable safety apparatus can utilize as few as one or as many as several pivotally mounted railing elements, at different locations above platform 18, even with platform 18, and/or below platform 18, as desired. Thus, a single pivotal railing element could be provided adjacent to the upper portion of safety railing 38, between railing 38 and platform 18, or below platform 18, as desired.

Here, it should be noted that although safety apparatus 14 as disclosed and described above is utilized in association with a fixed railing extending at least partially around an elevated platform of a ready-mix truck, the present invention could be utilized in association or connection with other elevated apparatus and structures, including, but not limited to, just the upper regions of a ladder, or a platform without a ladder per se associated therewith. Additionally, it should be noted that alternative constructions, for instance, the upper end of arm 88 could alternatively be connected to railing element 70 instead of to railing element 54, and could be connected directly to the railing element, instead of by connecting link 98. However, an advantage of connection using a linkage arrangement such as arrangement 90 including a link such as link 96 arranged and located as shown is that loads applied against arm 88 when deploying railing elements 54 and 70 are in tension, and any loads exerted, for instance, by a person falling against either railing element 54 or element 70, are in tension, and thus would not tend to exert a buckling or bending force against arm 88, or link 96. Also, use of link 96 enables arm 88 to be spaced a desired distance from other structural elements of truck 12, including ladder 22, such that potential pinch points are avoided. In this regard, it should be noted that it is contemplated that arm 88 could be advantageously positioned for use as a hand rail and could be located at any desired location in the vicinity of ladder 22. Arm 88 could also alternatively be connected to other apparatus on truck 12 so as to be movable for moving the railing element or elements between the stored and deployed position, such as a hand or foot operated lever or the like. The railing element or elements could also be deployed automatically using a fluid cylinder or cylinders, a servo, or other actuator. As noted above, railing elements 54 and 70, when in their folded positions, reduce the forward and rearward profile of truck 12 compared to when deployed, and provide a sufficient impediment or barrier to moving or climbing onto platform 18, such that it will be less likely that a person would climb to a dangerous height without first deploying railing elements 54, and/or 70. It should be noted, however, that alternatively, railing elements 54 and/or 70 could have a stored position which extends downwardly at a more vertical orientation, or upwardly at a desired orientation, as desired.

Lastly, referring again to FIG. 5, first railing element 54 is shown having an outward horizontal extent, denoted by distance F as measured from pin 68 which is preferably equal to from about 15 to about 24 inches, which has been found to provide an area 62 (FIG. 2) large enough for an average adult male to pass through, while providing adequate fall protection. Similarly, second railing element 70 has an outward extent, denoted by distance G, which is preferably from about 30 to about 42 inches as measured from pin 80 and provides an area 84 (FIG. 2) sufficiently large for passage of a person when climbing onto or off of platform 18, while providing the desired fall protection for the person. Here, it should be noted that distances F and G are measured from pins 68 and 80, respectively, the locations of which pins generally correspond to the outer peripheral edge of platform 18 and also access region 50 (FIG. 2). It should also be noted that distances F and G can be different and varied for a desired application or truck, to provide a desired or required space for passage of a person through areas 62 and 84 as well as the level of fall protection sought.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

What is claimed is:

1. A safety guard for above a peripheral region of an elevated platform on a ready-mix truck for increasing safety of a person moving through the peripheral region between the platform and a ladder located generally below the peripheral region, the safety guard comprising:
an elongate rigid railing element having opposite end portions and a concave portion disposed therebetween, the end portions being supported by structure on the truck for pivotal movement of the railing element between a deployed position located generally above and extending around and outwardly of the peripheral region so as to allow a person to move between the ladder and the platform while providing protection for the person against falling outwardly away therefrom, and a stored position angularly related to the deployed position above or below the deployed position; and
an element connected to the railing element so as to extend downwardly therefrom to a location below the platform, and positionable in a predetermined position for holding the railing element in the deployed position.

2. The safety guard of claim 1, wherein the element extending downwardly from the railing element to a location below the platform comprises an elongate arm movable for moving the railing between the deployed position and the stored position from the location below the platform.

3. The safety guard of claim 2, wherein the ladder includes an upper ladder portion fixedly mounted to the truck and a lower ladder portion mounted for pivotal movement relative to the upper ladder portion between a folded position oriented generally parallel to or at a small acute angle to the upper ladder portion and an unfolded position generally parallel to and extending downwardly from the upper ladder portion, the arm being connected between the railing element and the lower ladder portion and including a linkage arrangement movable for positioning the railing element in the deployed position when the lower ladder portion is moved to the unfolded position, and for positioning the railing element in the stored position when the lower ladder portion is moved to the folded position.

4. The safety guard of claim 3, wherein the lower ladder portion when in the unfolded position will hold the railing element in the deployed position until moved by a person toward the folded position.

5. The safety guard of claim 1, further comprising a second elongate railing element having opposite end portions and a concave portion disposed therebetween supported for pivotal movement between a deployed position above and outwardly of the peripheral region and a stored position angularly related to the deployed position.

6. The safety guard of claim 1, wherein the concave portion of the railing element has an arcuate shape.

7. The safety guard of claim 6, wherein the concave portion has an extent as measured generally outwardly from the peripheral region of the platform of from about 15 to about 42 inches.

8. Foldable safety apparatus for providing fall protection for a person when on an elevated element on a ready-mix concrete truck, comprising:
support members located above and adjacent to opposite sides of the elevated element, respectively;
an elongate, rigid railing element having opposite end portions pivotally connected to the support members, respectively, such that the railing element is supported above a peripheral portion of the elevated element generally between the opposite sides thereof, the railing element having a generally concave portion extending between the end portions thereof; and
an elongate arm having a first end portion pivotally connected to the railing element, such that the arm extends downwardly therefrom to a location below the elevated element, the arm being movable for pivotally moving the railing element between a deployed position wherein the concave portion extends outwardly from the support members and the elevated element a predetermined distance above the elevated element, and a stored position angularly related to the deployed position, the arm having a second end portion opposite the first end portion thereof supportable on an element of the truck for holding the railing element in the deployed position.

9. The foldable safety apparatus of claim 6, wherein the element on the truck comprises a ladder pivotally mounted to the truck for movement between a folded position and an unfolded position disposed generally between the elevated element and a surface on which the truck is located.

10. The foldable safety apparatus of claim 9, wherein the ladder is movable downwardly from the folded position to the unfolded position, and the elongate arm is pivotally connected to the railing element by a link fixedly mounted to the railing element and angularly oriented relative thereto, such that when the ladder is pivotally moved downwardly from the folded position to the unfolded position, the arm is pulled downwardly thereby so as to pivotally move the railing element from the stored position to the deployed position, and such that when the ladder is pivotally moved from the unfolded position to the folded position, the arm is moved upwardly to pivotally move the railing element from the deployed position to the folded position.

11. The foldable safety apparatus of claim 10, wherein when the ladder is in the unfolded position, it will hold the arm sufficiently for holding the railing element in the deployed position.

12. The foldable safety apparatus of claim 11, further comprising a second elongate, rigid railing element having opposite end portions pivotally connected to support members adjacent to opposite sides of the elevated element, respectively, such that the second railing element is supported above the peripheral portion of the elevated element generally between the opposite sides thereof, the second railing element having a generally concave portion extending between the end portions thereof, the second railing element being connected to the arm so as to be pivotally movable thereby between a deployed position wherein the concave portion of the second railing element extends generally horizontally outwardly from the support members and the elevated element a predetermined second distance above the elevated element, and a stored position angularly related to the deployed position thereof.

13. The foldable safety apparatus of claim 12, wherein the concave portion of the railing elements each have an arcuate shape.

14. The foldable safety apparatus of claim 13, wherein the second railing element is located between the first named railing element and the elevated element and has an outward extent relative to the elevated element which is greater than an outward extent of the first named railing element.

15. The foldable safety apparatus of claim 13, wherein the second railing element when in the folded position thereof extends across the ladder so as to provide a barrier to movement upwardly beyond the second railing element.

16. Foldable safety apparatus for above a peripheral region of an elevated platform on a ready-mix concrete truck including a ladder extending upwardly to the peripheral region of the platform, the safety apparatus comprising:
support members located above and adjacent to opposite sides of the peripheral region, respectively;
an elongate, rigid railing element having opposite end portions pivotally connected to the support members, respectively, such that the railing element is supported above the peripheral region, the railing element including an intermediate portion disposed between the opposite end portions thereof, the intermediate portion having a generally concave shape defining a predetermined area; and
an arm having a first end connected to the railing element and extending downwardly therefrom, movable for pivotally moving the railing element between a first position extending outwardly from the support members generally above the peripheral region such that the predetermined area is generally above the predetermined region, and a second position angularly related to the first position wherein the intermediate portion extends across the peripheral region for obstructing passage through an area above the peripheral region.

17. The safety apparatus of claim 16, wherein the ladder includes a foldable lower portion, and the arm is connected to the foldable lower portion so as to move the railing element to the first position when the lower ladder portion is unfolded.

18. The safety apparatus of claim 16, wherein the intermediate portion of the railing element has an arcuate shape.

19. The safety apparatus of claim 16, further comprising a second elongate, rigid railing element pivotally supported above the peripheral region of the platform, the second railing element including an intermediate portion having a concave shape, the second railing element being connected to the arm for movement thereby between a first position extending outwardly relative to the platform above the peripheral region and a second position angularly related to the first position thereof.

20. The safety apparatus of claim 19, wherein the second railing element is disposed between the peripheral region and the first named railing element.

21. Foldable safety apparatus for providing fall protection for a person when on an elevated element on a ready-mix concrete truck, the elevated element being located above a ladder on the truck having an upper portion and a lower portion, the lower portion being mounted for pivotal movement relative to the upper portion between a folded position generally beside the upper portion and an unfolded position extending downwardly from the upper portion, the safety apparatus comprising:
an elongate, rigid railing element having opposite end portions pivotally connected to elements on the truck, respectively, such that the railing element is supported above a peripheral portion of the elevated element, the railing element having a generally concave intermediate portion extending between the end portions thereof; and
an elongate arm having a first end portion pivotally connected to the railing element and extending downwardly therefrom to a second end portion of the arm pivotally connected to the lower ladder portion, such that the arm is movable by upward movement of the lower ladder portion relative to the upper ladder portion to move the railing element to a deployed position wherein the concave intermediate portion thereof extends outwardly above the peripheral portion of the elevated element, and the arm is movable by downward movement of the lower ladder portion to move the railing element from the deployed position to a stored position angularly related to the deployed position and extending across an area above the peripheral region of the elevated element for impeding movement of a person between the elevated element and the ladder.
